(19) United States
(12) Patent Application Publication
(10) Pub. No.: US 2009/0146433 A1
(43) Pub. Date: Jun. 11, 2009

(54) Method and apparatus for fabricating wind turbine components

(75) Inventors: Nicholas Keane Althoff, Ware Shoals, SC (US); Amir Riahi, Langhorne, PA (US); Andrew John Billen, Daarlerveen (NL); Jan Willem Bakhuis, Nijverdal (NL)

Correspondence Address: PATRICK W. RASCHE (22402);ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 12/001,069

(22) Filed: Dec. 7, 2007

(51) Int. Cl. F03D 9/00; B29C 65/54; B29C 65/72; B32B 38/00; B29C 65/00; B23P 15/04; F01D 5/14

(52) U.S. Cl. 290/55; 156/305; 156/242; 156/145; 156/280; 156/60; 29/889.7; 416/223 R

(57) ABSTRACT

A method of assembling a wind turbine blade includes forming a preform pressure surface member and a preform suction surface member. The method also includes forming at least one of a leading edge and a trailing edge. One method of forming the leading edge or the trailing edge includes coupling a preform cap member to one of a portion of the preform pressure surface member and a portion of the preform suction surface member. At least a portion of one of the preform pressure surface member and the preform suction surface member overlap at least a portion of the preform bond cap member. Another method of forming the leading edge or the trailing edge includes coupling the preform pressure surface member to the preform suction surface member wherein at least a portion of the preform pressure surface member overlaps at least a portion of the preform suction surface member.

### BACKGROUND OF THE INVENTION

This invention relates generally to rotary machines and more particularly, to methods and apparatus for fabricating wind turbine blades.

Generally, a wind turbine generator includes a rotor having multiple blades. The rotor is sometimes mounted within a housing, or nacelle, that is positioned on top of a base, for example a truss or tubular tower. At least some known utility grade wind turbines (i.e., wind turbines designed to provide electrical power to a utility grid) can have rotor blades of 30 meters (m) (100 feet (ft)) or more in length.

Many known wind turbine blades are generally difficult and time consuming to assemble. Some known methods of fabricating wind turbine blades include forming a plurality of members using resin transfer molding techniques. Such techniques typically include placing a preshaped fiber reinforcement preform into a closed molding of a similar shape, transferring a resin into the mold such that the resin impregnates the reinforcing fibers, and allowing the resin to cure to form a fiberglass-reinforced wind turbine blade member. A variety of members are formed in this manner and are assembled together to fabricate wind turbine blades.

At least one method of assembling wind turbine blades includes using adhesives applied to some of the bonding surfaces, for example, adhesively bonding two members together to define a blade cross section having a leading edge and a trailing edge. This method uses a large amount of adhesives that increases assembly costs due to extensive material usage as well as the labor usage to apply the adhesive. Moreover, as the associated members are placed in contact with each other, adhesive material is squeezed out of the associated joints and the wastage is disposed of. Also, manually applying the adhesive facilitates uneven adhesive thicknesses across the length of the blade (which facilitates squeezed wastage as described above), and void formation. Furthermore, joining the fiberglass members is typically performed at a blade chord line, wherein member alignment is made more difficult and erosion resistance and aerodynamic integrity may be deleteriously affected.

### BRIEF DESCRIPTION OF THE INVENTION

In one aspect, a method of assembling a wind turbine blade is provided. The method includes forming a preform pressure surface member and a preform suction surface member. The method also includes forming at least one of a leading edge and a trailing edge. One method of forming the leading edge or the trailing edge includes coupling a preform cap member to one of a portion of the preform pressure surface member and a portion of the preform suction surface member. At least a portion of one of the preform pressure surface member and the preform suction surface member overlap at least a portion of the preform bond cap member. Another method of forming the leading edge or the trailing edge includes coupling the preform pressure surface member to the preform suction surface member wherein at least a portion of the preform pressure surface member overlaps at least a portion of the preform suction surface member.

In another aspect, a wind turbine blade is provided. The wind turbine blade includes a pressure surface member, a suction surface member and at least one of a leading edge and a trailing edge. Either the leading and trailing edge is formed with one of a cap member overlapping a portion of the pressure surface member and a portion of the suction surface member, or formed with an overlapping region that is formed with at least a portion of the pressure surface member overlapping at least a portion of the suction surface member.

In a further aspect, a wind turbine generator is provided. The wind turbine generator includes an electric generator rotatingly coupled to a hub and a wind turbine blade coupled to the hub. The wind turbine blade includes a pressure surface member, a suction surface member and at least one of a leading edge and a trailing edge. Either the leading and trailing edge is formed with one of a cap member overlapping a portion of the pressure surface member and a portion of the suction surface member, or formed with an overlapping region that is formed with at least a portion of the pressure surface member overlapping at least a portion of the suction surface member.

### BRIEF DESCRIPTION OF THE DRAWINGS

FIG. 1 is an orthographic view of an exemplary wind turbine generator;

FIG. 2 is a cross-sectional schematic view of an exemplary rotor blade that may be used with the wind turbine generator shown in FIG. 1;

FIG. 3 is a cross-sectional schematic view of an unassembled portion of the rotor blade shown in FIG. 2 enclosed within an exemplary assembly apparatus;

FIG. 4 is a cross-sectional schematic view of a portion of the rotor blade shown in FIG. 2;

FIG. 5 is a cross-sectional schematic view of a portion of an alternative rotor blade that may be used with the wind turbine generator shown in FIG. 1; and

FIG. 6 is a cross-sectional schematic view of a portion of another alternative rotor blade that may be used with the wind turbine generator shown in FIG. 1.

### DETAILED DESCRIPTION OF THE INVENTION

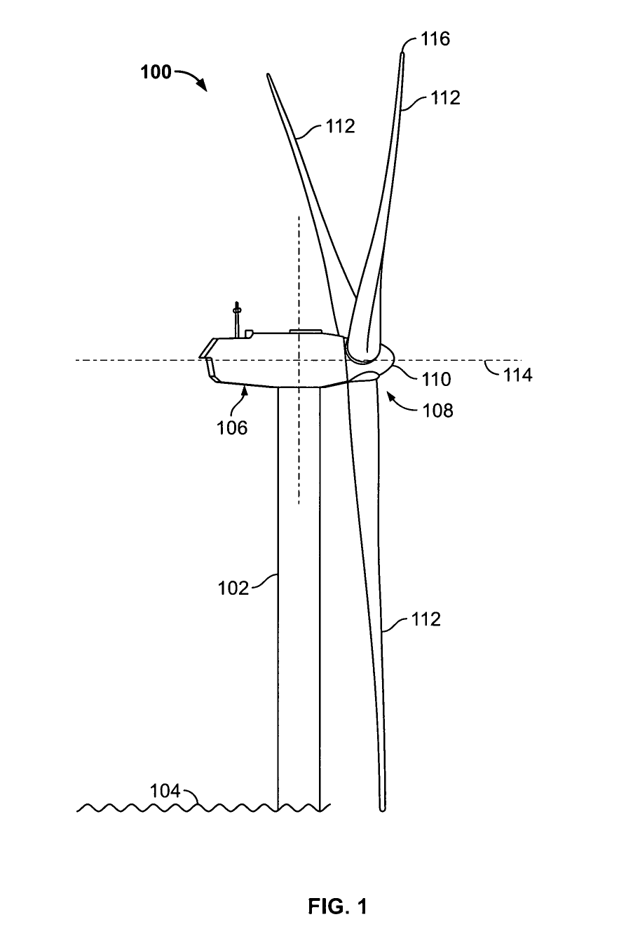

FIG. 1 is a schematic illustration of an exemplary wind turbine generator 100. In the exemplary embodiment, wind turbine generator 100 is a horizontal axis wind turbine. Alternatively, wind turbine 100 may be a vertical axis wind turbine. Wind turbine 100 has a tower 102 extending from a supporting surface 104, a nacelle 106 mounted on tower 102, and a rotor 108 coupled to nacelle 106. Rotor 108 has a rotatable hub 110 and a plurality of wind turbine blades, or rotor blades 112, coupled to hub 110. In the exemplary embodiment, rotor 108 has three rotor blades 112. In an alternative embodiment, rotor 108 may have more or less than three rotor blades 112. A center line 114 extends through nacelle 106 and hub 110. Each rotor blade 112 includes a tip 116. In the exemplary embodiment, tower 102 is fabricated from tubular steel and includes a cavity (not shown in FIG. 1) extending between supporting surface 104 and nacelle 106. In an alternative embodiment, tower 102 is a lattice tower. The height of tower 102 is selected based upon factors and conditions known in the art. Blades 112 are positioned about rotor hub 110 to facilitate rotating rotor 108 to transfer kinetic energy from the wind into usable mechanical energy, and subsequently, electrical energy.

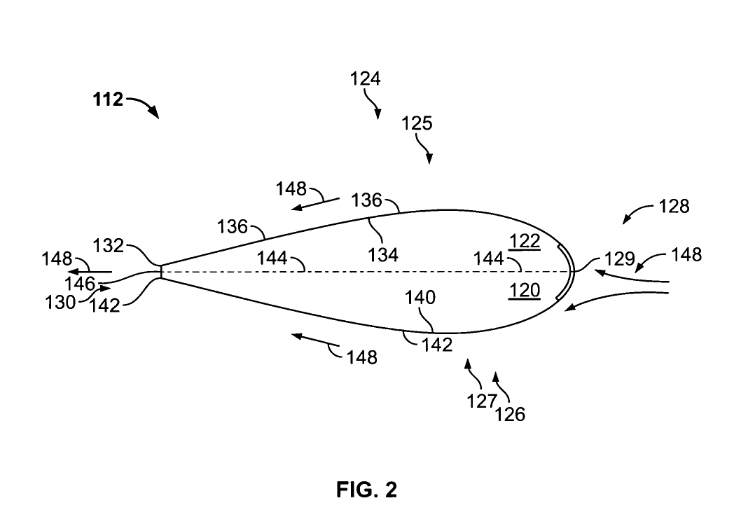

FIG. 2 is a cross-sectional view of rotor blade 112 which may be used with the wind turbine generator shown in FIG. 1. More specifically, each blade 112 includes a pressure surface member, or first shell assembly, hereon referred to as lower shell 120. Also, each blade 112 includes a suction surface member, or second shell assembly, hereon referred to as upper shell 122. Upper shell 122 includes a suction sidewall 124 that at least partially defines a blade suction side 125. Lower shell 120 includes a pressure sidewall 126 defining a blade pressure side 127. Sidewalls 124 and 126 are joined at a leading edge 128 and at a trailing edge 130. More specifically, leading edge 128 includes at least one bond cap 129 fixedly coupled to upper shell 122 and lower shell 120. Suction sidewall 124 has a varying contour, extends from leading edge 128 to a suction side terminus 132, has an interior surface 134 and has an exterior surface 136. Pressure sidewall 126 has a varying contour, extends from leading edge 128 to a pressure side terminus 138, has an interior surface 140 and has an exterior surface 142. Rotor blade 112 defines a chord line 144 as the distance between leading edge 128 and a midpoint 146 of trailing edge 130. Fluid 148 (shown as arrows) flows around blade 112. It should be appreciated that “fluid” as used herein includes any material or medium that flows, including, but not limited to, gas, air and liquids.

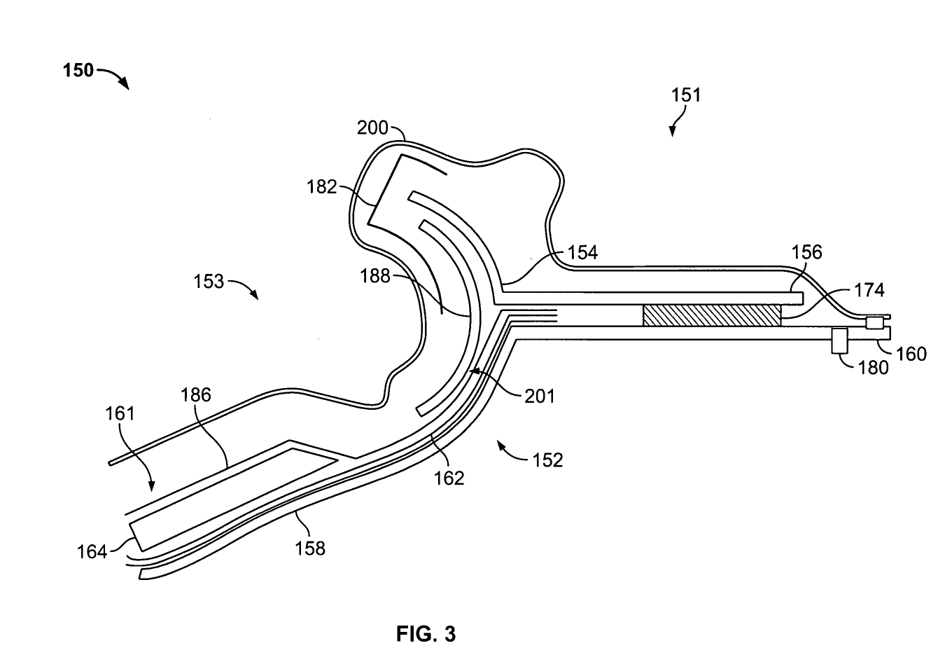

FIG. 3 is a cross-sectional schematic view of an unassembled portion 153 of rotor blade 112 enclosed within an exemplary assembly apparatus 150. Portion 153 and apparatus 150 are used to partially form assembled rotor blade 112. Apparatus 150 includes a bond cap fixture 151 coupled to an exemplary lower shell mold 152. Bond cap fixture 151 includes a bond cap support portion 154 fixedly coupled to a bond cap fixture flange 156. Portion 154 is configured to receive and support at least a portion of at least one bond cap preform member 188. Mold 152 includes a shell formation portion 158 fixedly coupled to a mold flange 160.

Unassembled portion 153 includes a preform pressure member, or lower shell preform member 161, and an adjoining bond cap preform member 188. Lower shell preform member 161 forms lower shell 120 (shown in FIG. 2) as discussed further below. Similarly, bond cap preform member 188 forms bond cap 129 also discussed further below. A portion of a lower shell preform member 161 is shown positioned within mold 152. Specifically, member 161 includes a plurality of pressure sidewall fiberglass layers 162 and a foam layer 164 that are positioned within portion 158. In the exemplary embodiment, layers 162 are formed with biax. Alternatively, layers 162 are formed from materials that include, but are not limited to, triax.

Apparatus 150 further includes a silicon rubber insert 174 that is inserted between flanges 156 and 160. Insert 174 is configured to mitigate resin flow out of apparatus 150 via flanges 156 and 160. In the exemplary embodiment, insert 174 has any dimensions that facilitate operation of apparatus 150 as described herein.

Apparatus 150 also includes a vacuum port 180 that penetrates flange 160. Apparatus 150 further includes at least one exemplary prefabricated clip 182. Clip 182 is configured to secure bond cap preform member 188 to bond cap support portion 154. Moreover, each of clips 182 is configured for a specific position (not shown) along a longitudinal length (not shown) of bond cap fixture 151. Furthermore, each clip 182 is configured to include an induced closing bias that facilitates a mild “pinching” action as described below as well as facilitating ease of removal. In the exemplary embodiment, clip 182 has any dimensions that facilitate operation of apparatus 150 as described herein.

Additional fiberglass layers 186 are positioned on top of foam 164 and fiberglass layers 162 within shell formation portion 158 and up to mold flange 160. In the exemplary embodiment, layers 186 are formed with biax. Alternatively, layers 186 are formed from materials that include, but are not limited to, triax. At least one bond cap preform member 188 is positioned on top of layers 186 and against bond cap support portion 154 such that at least a portion of each of members 188 and 161 are in direct contact with each other. Member 188 is configured to form bond cap 129 (shown in FIG. 2). Specifically, prior to resin infusion and curing, bond cap preform member 188 is fabricated with fiberglass layers (not shown) in a manner similar to that for preform member 161. Moreover, in the exemplary embodiment, member 188 is formed from triax. Alternatively, member 188 is formed from any material that includes, but is not limited to, biax. In some embodiments, at least one foam layer (not shown) is used. In the exemplary embodiment, preform member 188 has any dimensions that facilitate forming bonding cap 129 within blade 112 as described herein. Bond cap 129 is configured to mitigate deflection and movement of bond cap 129 to approximately 2 mm (0.0787 in.) or less.

Bond cap preform member 188 is secured to apparatus 150 along the longitudinal length (not shown) of bond cap fixture 151 via methods that include, but are not limited to, a plurality of clips 182, glass tape, clamping devices with padded jaws and spring-loaded clips (neither shown). In the exemplary embodiment, the clamps and spring-loaded clips are used within a 15 meter (m) (49.2 feet (ft)) longitudinally inboard-most portion (not shown) of bond cap fixture 151 and clips 182 are positioned at 0.5 m (19.7 in.) intervals along the longitudinal length of bond cap fixture 151. Alternatively, clips 182, tape, clamps and spring-loaded clips are positioned at any portion of fixture 151 at any intervals that facilitate operation of apparatus 150 as described herein. The induced “pinch” bias within clips 182 facilitates securing bond cap preform member 188 to fixture 151 and mold 152 with a predetermined alignment while mitigating deleterious distortion of member 188.

Also, alternatively, methods of securing bond cap preform member 188 to apparatus 150 include stitching at least a portion of bond cap preform member 188 to at least a portion of lower shell preform member 161 with a stitching material (not shown). Subsequently, the method includes securing at least a portion of the stitching material to one of lower mold 152 and bond cap fixture 151. A further alternative method of securing bond cap preform member 188 to apparatus 150 includes positioning at least one glass tie (not shown) over at least a portion of bond cap fixture 151 and bond cap preform member 188. Moreover, another alternative method of securing bond cap preform member 188 to apparatus 150 includes applying at least one bonding material (not shown) to at least a portion of bond cap fixture 151 and bond cap preform member 188.

Assembly apparatus 150 also includes at least a portion of an infusion apparatus, or vacuum bag 200. Bag 200 is positioned over substantially all of apparatus 150 and sealed. Subsequently, in the exemplary embodiment, air is withdrawn from inside apparatus 150 via vacuum port 180 and resin is introduced via ports (not shown) such that resin infusion of layers 186 and 162, foam 164, and bond cap preform member 188 is facilitated. In the exemplary embodiment, vacuum assisted resin transfer methods (VARTM), sometimes referred to as vacuum assisted resin injection (VARI) methods, are used. Alternatively, any resin transfer molding (RTM) methods that facilitate integrally bonding bond cap preform member 188 to lower shell preform member 161 as described herein are used. Upon completion of resin infusion, member 161 and member 188 are cured together to form an infused joint 201, thereby integrally bonding bond cap 129 to lower shell 120 (both shown in FIG. 2). Subsequent to curing, at least one bonding material is injected into and/or applied to selected regions (not shown) between bond cap 129 and lower shell 120.

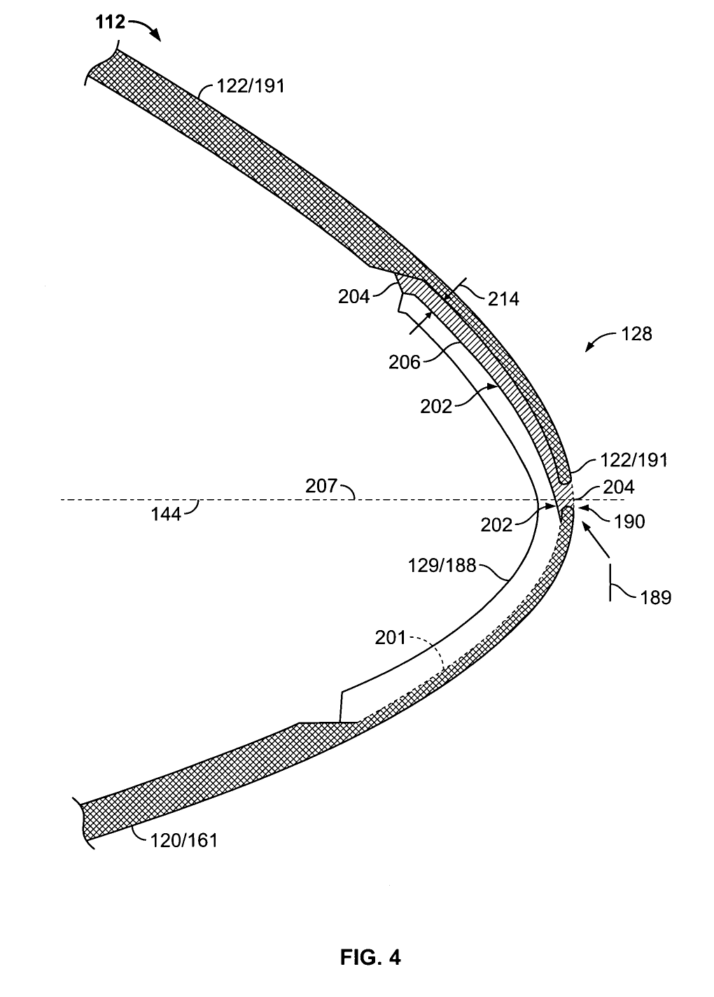

FIG. 4 is a cross-sectional schematic view of a portion of rotor blade 112. In the exemplary embodiment, bond cap 129 is integrally formed with lower shell 120. Alternatively, bond cap 129 is integrally formed with upper shell 122. In the exemplary embodiment, infusion of resin within bond cap preform member 188 and lower shell preform member 161 as described above is performed longitudinally along leading edge 128 up to a region within approximately 3 m (9.8 ft) of a longitudinally outermost portion of blade 112. Also, in the exemplary embodiment, a remainder of leading edge 128 and substantially all of trailing edge 130 (shown in FIG. 2) are sealed using methods that include, but are not limited to, hand lay-up (HLU) methods, or operations and prepreg material methods.

In general, both HLU operations and prepreg material methods include use of at least one sealing member 189. Further, in general, HLU operations include applying a resin (not shown) to at least a portion of a non-resin-impregnated piece, or sheet, of fiberglass or cloth to form an at least partially-resin-impregnated sealing member 189. Moreover, in general, prepreg methods include using a sealing member 189 that, in this case, is a previously resin-impregnated piece, or sheet, of fiberglass or cloth. HLU operations and prepreg methods both include positioning at least a portion of resin-impregnated sealing member 189 such that it contacts at least a portion of lower shell 120 and at least a portion of bond cap 129 subsequent to curing of shell 120 and cap 129. Alternatively, sealing members 189 are positioned on at least a portion of each of lower shell preform member 161/lower shell 120 and an upper shell preform member 191/upper shell 122 either after partial curing or prior to any curing. Regardless, performing HLU operations and/or prepreg methods as described herein facilitates at least partially forming a HLU and/or pregreg joint 190. Also, alternatively, any method of bonding that includes, but is not limited to, HLU operations, prepreg methods, and RTM, in any portions of leading edge 128, that facilitates integrally bonding lower shell 120 to bond cap 129 as described herein are used.

Upper shell 122 is fabricated in a manner substantially similar to lower shell 120, with the exception that upper shell 122 is formed from upper shell preform member 191. Upper shell 122 is lowered onto bond cap 129 subsequent to resin infusion and curing of upper shell preform member 191 to form upper shell 122 using methods similar to that as described above. Therefore, bond cap 129 is configured to receive upper shell 122. Specifically, prior to resin infusion and curing, bond cap preform member 188 is formed as described above such that after curing and formation of bond cap 129, a bonded region, or joint 202, is at least partially formed between bond cap 129 and a portion of upper shell 122. Moreover, bonded joint 202 extends between a portion of bond cap 129 and a portion of lower shell 120, and may also extend between portions of lower shell 120 and upper shell 122.

Further, in the exemplary embodiment, prior to lowering upper shell 122 onto bond cap 129, an adhesive layer 204 is formed on a surface 206 of bond cap 129. Therefore, when upper shell 122 is lowered onto bond cap 129, adhesion of shell 122 to bond cap 129 is facilitated fully forms bonded joint 202. Bonded joint 202 has a thickness dimension 214. In the exemplary embodiment, dimension 214 is approximately 6 mm (0.236 in.). Alternatively, dimension 214 has any value that facilitates bonding bond cap 129 within blade 112 as described herein.

Alternatively, in lieu of forming adhesive layer 204, upper shell 122 is lowered into bond cap 129, thereby defining at least one void (not shown) in the vicinity of surface 206. Resin is injected into such voids to at least partially form bonded joint 202.

Additional methods of sealing bond cap 129 to shell 122 include, but are not limited to, HLU operations. In the exemplary embodiment, bonding upper shell 122 to lower shell 120 and integrated bond cap 129 defines a bond line 207 that is substantially coincident with chord line 144. Alternative embodiments are discussed further below. Once sealing operations are completed, bond cap 129, adhesive 204, HLU/prepreg joint 190, infusion joint 201, bonded joint 202, and portions of upper shell 122 and lower shell 120 cooperate to form leading edge 128.

An exemplary method of assembling wind turbine blade 112 includes forming a preform pressure surface member, or lower shell preform member 161, that subsequently forms lower shell assembly 120. The method also includes forming a preform suction surface, or upper shell preform member 191, that subsequently forms upper shell assembly 122. The method further includes forming at least one of leading edge 128 and trailing edge 130. One method of forming leading edge 128 and trailing edge 130 includes coupling preform cap member 188 to at least one of a portion of lower shell preform member 161 and a portion of upper shell preform member 191. A portion of at least one of lower shell preform member 161 and upper shell preform member 191 overlap at least a portion of preform bond cap member 188.

Using the above methods to form blade 112 facilitates reducing adhesive usage and wastage as well as overall blade 112 fabrication time and costs, including, substantially eliminating production floor use for prefabrication of bond cap 129 independent of the remainder of blade 112 components. Moreover, blade labor and material production costs that include, but are not limited to, bond cap prefabrication, adhesive application to bond cap 129 for bonding with lower shell 120, resin curing energy usage, miscellaneous consumable usage, bond cap molds, and adhesive wastage are reduced or eliminated. Furthermore, the overall quality of forming blade 112 is improved by facilitating a mitigation of void formation and component misalignment. Also, in the exemplary embodiment, an improvement of shear strength of the integral bond of approximately 150% over that associated with the adhesive alone is realized. Therefore, off-line blade repair costs are also reduced.

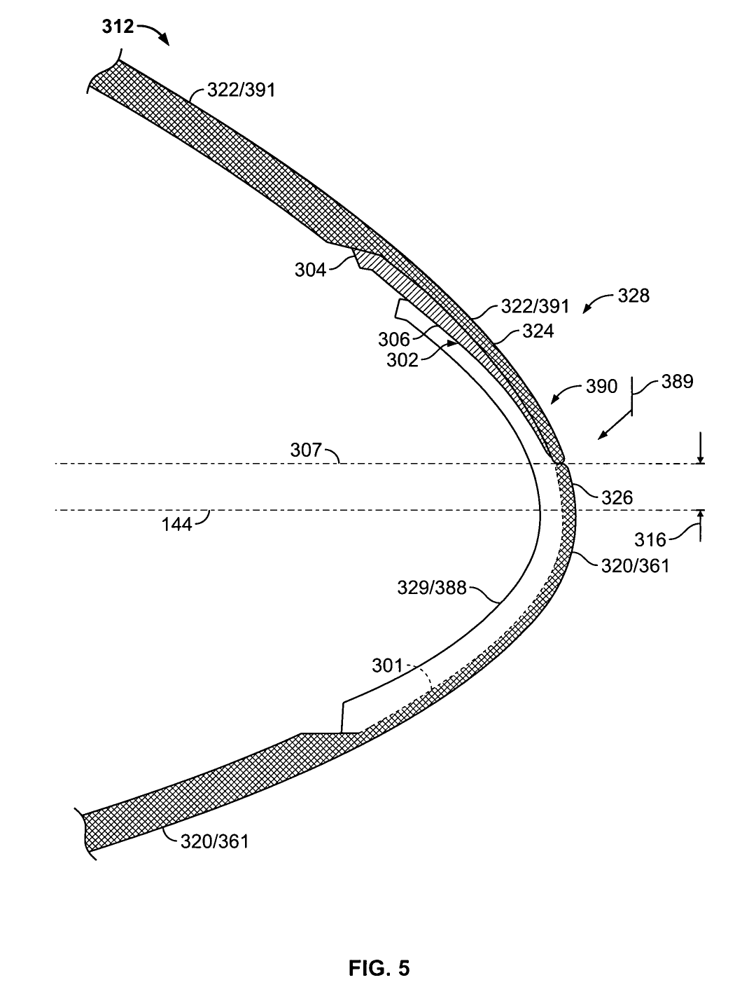

FIG. 5 is a cross-sectional schematic view of a portion of an alternative rotor blade 312 that may be used with wind turbine generator 100 (shown in FIG. 1). Alternative rotor blade 312 includes an alternative pressure surface member, or first shell assembly, hereon referred to as alternative lower shell 320. Shell 320 is formed in a substantially similar manner to shell 120 (shown in FIGS. 2 and 4) with the exception that shell 320 extends beyond chord line 144 and is formed from an alternative lower shell preform member 361. Shell 320 includes an alternative pressure sidewall 326. Also, each blade 312 includes an alternative suction surface member, or second shell assembly, hereon referred to as alternative upper shell 322. Shell 322 is formed in a substantially similar manner to shell 122 (shown in FIGS. 2 and 4) with the exception that shell 322 does not extend to chord line 144 and is formed from an alternative upper shell preform member 391. Shell 322 includes an alternative suction sidewall 324.

Therefore, in the alternative embodiment, shell 320 and 322 cooperate to form a shifted split line, or an alternative bond line 307 that is shifted, or separated by a distance 316 extending away from chord line 144 toward sidewall 324. Alternatively, blade 312 is configured to include alternative bond line 307 that is separated by distance 316 extending away from chord line 144 toward sidewall 326. In the exemplary embodiment, distance 316 is approximately 5.0 mm (0.2 in). Alternatively, distance 316 is any distance that facilitates operation of blade 312 as described herein.

Alternative blade 312 also includes an alternative bond cap 329, formed from an alternative bond cap preform member 388, that is substantially similar to bond cap 129 (shown in FIGS. 2 and 4) with the exception that bond cap 329 includes a surface 306 that at least partially defines an alternative bonded region, or joint 302, wherein surface 306 and bonded joint 302 differ from, respectively, surface 206 and bonded joint 202 (both shown in FIG. 4) by substantially extending no further than alternative bond line 307. Subsequently, an alternative adhesive 304 is applied to surface 306 to facilitate bonding shell 322 to bond cap 329. Adhesive 304 is substantially similar to adhesive 204 (shown in FIG. 4) with the exception that adhesive 304 substantially extends no further than bond line 307. Moreover, integrated bond cap 329 and lower shell 320 include an alternative infusion joint 301. Alternative infusion joint 301 is substantially similar to infusion joint 201 (shown in FIGS. 3 and 4) with the exception that joint 301 extends beyond chord line 144 to approximately bond line 307.

Alternative blade 312 may include resin injected into joint 302 and may further include an alternative sealing member 389 that facilitates forming an alternative HLU and/or prepreg joint 390. Once sealing operations are completed, bond cap 329, adhesive 304, HLU/prepreg joint 390, infusion joint 301, bonded joint 302, and portions of upper shell 322 and lower shell 320 cooperate to form an alternative leading edge 328.

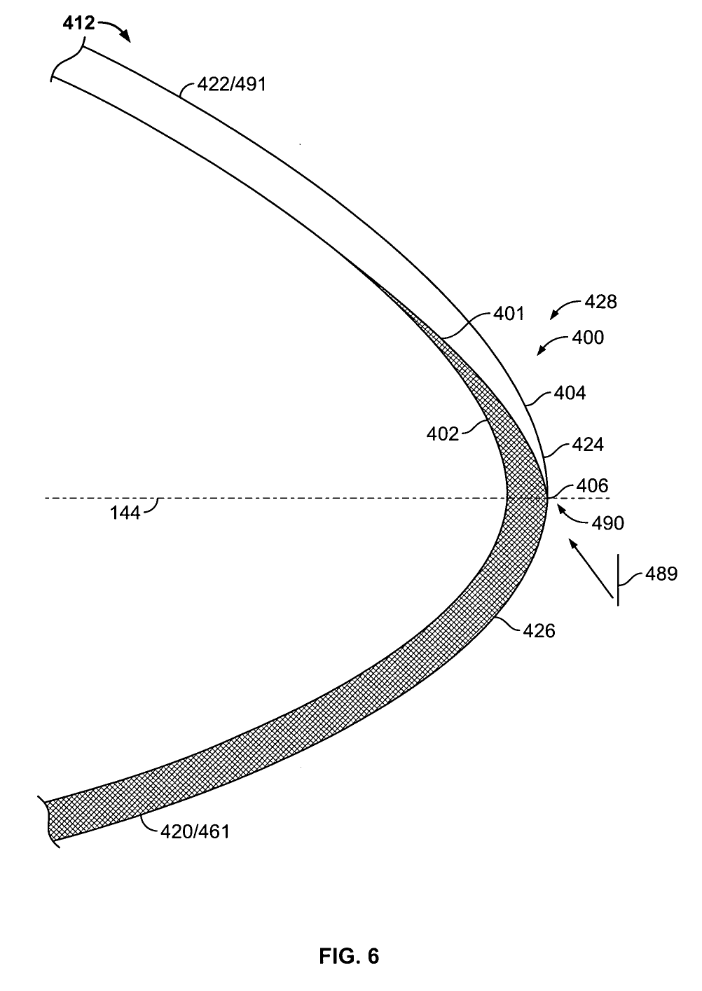

FIG. 6 is a cross-sectional schematic view of a portion of another alternative rotor blade 412 that may be used with wind turbine generator 100 (shown in FIG. 1). Alternative rotor blade 412 includes an alternative pressure surface member, or first shell assembly, hereon referred to as alternative lower shell 420. Shell 420 is formed in a substantially similar manner to shell 120 (shown in FIGS. 2 and 4) with the exception that shell 420 is formed from an alternative lower shell preform member 461. Shell 420 includes a first overlapping portion 402 that extends beyond chord line 144 and an alternative pressure sidewall 426. Also, each blade 412 includes an alternative suction surface member, or second shell assembly, hereon referred to as alternative upper shell 422. Shell 422 is formed in a substantially similar manner to shell 122 (shown in FIGS. 2 and 4) with the exception that shell 422 is formed from an alternative upper shell preform member 491. Shell 422 includes a second overlapping portion 404 that extends beyond chord line 144 and an alternative suction sidewall 424.

Moreover, in this alternative embodiment, overlapping portions 402 and 404 cooperate to form an overlapping region 400 that includes an alternative infusion joint 401. Also, in this alternative embodiment, overlapping portions 402 and 404 and infusion joint 401 cooperate to form a bond region 406. Specifically, bond region 406 is formed at the junction of sidewalls 424 and 426. Bond region 406 is further sealed with methods that include, but are not limited to, HLU operations, prepreg methods, and bonding with an adhesive. In some alternative embodiments, blade 412 further includes an alternative sealing member 489 that facilitates forming an alternative HLU/prepreg joint 490. Once sealing operations are completed, first and second overlapping portions 302 and 404, HLU/prepreg joint 490, infusion joint 401, and bond region 406 cooperate to form an alternative leading edge 428.

Further, in this alternative embodiment, bond region 406 is substantially coincident with chord line 144. Alternatively, overlapping regions 402 and 404 are fabricated such that bond region 406 extends beyond chord line 144 in either direction, that is toward either of sidewalls 424 and 426, with any distance that facilitates operation of alternative blade 412 as described herein.

An alternative method of assembling wind turbine blade 112, or more specifically, an alternative wind turbine blade 412, includes forming a preform pressure surface member, or lower shell preform member 461, that subsequently forms lower shell assembly 420. The method also includes forming a preform suction surface, or upper shell preform member 491, that subsequently forms upper shell assembly 422. The method further includes forming at least one of leading edge 428 and a trailing edge (not shown). One method of forming leading edge 428 and the trailing edge includes coupling preform pressure surface member 461 to preform suction surface member 491 wherein at least a portion of preform pressure surface member 461 overlaps at least a portion of preform suction surface member 491.

The methods and apparatus for fabricating a wind turbine blade described herein facilitate operation of a wind turbine system. Specifically, the wind turbine blade assembly as described above facilitates erosion resistance and aerodynamic performance. Therefore, the robust, wear-resistant assembly facilitates blade reliability, reduced maintenance costs and wind turbine system outages. Also, the blade fabrication methods described above facilitates reducing adhesive usage and wastage while mitigating any impact to overall blade fabrication time and costs. Specifically, such costs include substantially eliminating production floor use for prefabrication of bond caps independent of the remainder of the blade components. Moreover, blade labor and material production costs are reduced or eliminated. Furthermore, an effectiveness of forming the blade is improved by facilitating a mitigation of void formation and component misalignment.

Exemplary embodiments of wind turbine blade assemblies as associated with wind turbine systems are described above in detail. The methods, apparatus and systems are not limited to the specific embodiments described herein nor to the specific illustrated wind turbine blade assemblies.

While the invention has been described in terms of various specific embodiments, those skilled in the art will recognize that the invention can be practiced with modification within the spirit and scope of the claims.

What is claimed is:

1. A method of assembling a wind turbine blade, said method comprising:
forming a preform pressure surface member and a preform suction surface member; and
forming at least one of a leading edge and a trailing edge comprising one of:
coupling a preform cap member to at least one of one a portion of the preform pressure surface member and a portion of the preform suction surface member, wherein at least a portion of one of the preform pressure surface member and the preform suction surface member overlap at least a portion of the preform bond cap member; and
coupling the preform pressure surface member to the preform suction surface member wherein at least a portion of the preform pressure surface member overlaps at least a portion of the preform suction surface member.

2. A method in accordance with claim 1 wherein coupling a preform cap member to at least one of a portion of the preform pressure surface member and a portion of the preform suction surface member comprises:
adjoining at least a portion of the preform cap member to at least a portion of the preform pressure surface member;
infusing at least a portion of the preform cap member and at least a portion of the preform pressure surface member with a resin;
at least partially curing the preform pressure surface member to the bond cap member; and
applying at least one bonding material to at least a portion of the preform cap member and at least a portion of the preform pressure surface member.

3. A method in accordance with claim 2 wherein adjoining at least a portion of the preform cap member to at least a portion of the preform pressure surface member comprises:
positioning at least a portion of the preform pressure surface member within a first shell mold;
coupling a bond cap fixture to the first shell mold; and
coupling the preform cap member to at least a portion of the bond cap fixture.

4. A method in accordance with claim 2 wherein infusing at least a portion of the preform cap member and at least a portion of the preform pressure surface member with a resin comprises:
extending at least a portion of an infusion apparatus over at least a portion of the preform cap member and the preform pressure surface member;
sealing at least a portion of the infusion apparatus such that at least a portion of the preform pressure surface member and at least a portion of the preform cap member are at least partially isolated from external air sources;
removing at least a portion of air within at least a portion of the infusion apparatus; and
injecting a resin into at least a portion of the infusion apparatus.

5. A method in accordance with claim 1 wherein coupling a preform cap member to at least one of a portion of the preform pressure surface member and a portion of the preform suction surface member comprises one of:
applying a bonding substance to at least a portion of the preform cap member and the preform suction surface member; and
injecting a resin into at least one void defined between at least a portion of the preform suction surface member and at least a portion of the preform cap member.

6. A method in accordance with claim 1 wherein coupling a preform cap member to at least one of a portion of the preform pressure surface member and a portion of the preform suction surface member comprises at least one of:
coupling at least a portion of the preform cap member to the preform pressure surface member using a hand lay-up (HLU) operation comprising positioning at least one at least partially resin-impregnated piece such that at least a portion of the at least one partially resin-impregnated fabric piece contacts at least a portion of the preform pressure surface member and at least a portion of the preform cap member;
infusing a resin into at least a portion of preform pressure surface member and at least a portion of the preform cap member to a predetermined distance from a longitudinal substantially outermost portion of the wind turbine blade; and
positioning a prepreg fabric piece such that at least a portion of the prepreg fabric piece contacts at least a portion of the preform pressure surface member and at least a portion of the preform cap member.

7. A method in accordance with claim 1 wherein coupling the preform pressure surface member to the preform suction surface member comprises:
infusing a resin into at least a portion of the preform pressure surface member and at least a portion of the preform suction surface member; and
at least partially curing the preform pressure surface member and the preform suction surface member.

8. A method in accordance with claim 1 wherein forming at least one of a leading edge and a trailing edge further comprises forming a bond line and a blade chord line, wherein the bond line is defined at a predetermined distance between the blade chord line and one of:
at least a portion of a surface of the preform suction surface member; and
at least a portion of a surface of the preform pressure surface member.

9. A wind turbine blade comprising:
a pressure surface member;
a suction surface member; and
at least one of a leading edge and a trailing edge formed with one of:
a cap member overlapping a portion of said pressure surface member and a portion of said suction surface member; and
an overlapping region formed with at least a portion of said pressure surface member overlapping at least a portion of said suction surface member.

10. A wind turbine blade in accordance with claim 9 wherein said pressure surface member and said suction surface member cooperate to form a bond line and a blade chord line, wherein said bond line is defined at a predetermined distance between said blade chord line and one of:
at least a portion of a surface of said suction surface member; and
at least a portion of a surface of said pressure surface member.

11. A wind turbine blade in accordance with claim 9 wherein at least one of a leading edge and a trailing edge comprise at least one of:
at least one infused joint;
at least one bonded joint;
at least one prepreg fabric joint; and
at least one hand lay-up (HLU) joint.

12. A wind turbine blade in accordance with claim 11 wherein said at least one infused joint comprises:
at least one shell preform member;
said at least one bond cap preform member coupled to said at least one shell preform member; and
at least one resin material infused within at least a portion of said at least one shell preform member and at least a portion of said at least one bond cap preform member.

13. A wind turbine blade in accordance with claim 11 wherein said at least one bonded joint comprises:
at least one shell preform member;
said at least one bond cap preform member coupled to said at least one shell preform member; and
at least one bonding substance applied to at least a portion of said at least one shell preform member and at least a portion of said at least one bond cap preform member.

14. A wind turbine blade in accordance with claim 11 wherein each of said at least one hand lay-up (HLU) joint and at least one prepreg fabric joint comprise:
at least one shell preform member; and
at least one at least partially resin-impregnated piece coupled to said at least one shell preform member.

15. A wind turbine generator comprising:
an electric generator rotatingly coupled to a hub; and
a wind turbine blade coupled to said hub comprising:
a pressure surface member;
a suction surface member; and
at least one of a leading edge and a trailing edge formed with one of:
a cap member overlapping a portion of said pressure surface member and a portion of said suction surface member; and
an overlapping region formed with at least a portion of said pressure surface member overlapping at least a portion of said suction surface member.

16. A wind turbine generator in accordance with claim 15 wherein said wind turbine blade's pressure surface member and said suction surface member cooperate to form a bond line and a blade chord line, wherein said bond line is defined at a predetermined distance between said blade chord line and one of:
at least a portion of a surface of said suction surface member; and
at least a portion of a surface of said pressure surface member.

17. A wind turbine generator in accordance with claim 15 wherein at least one of said wind turbine blade's leading edge and trailing edge comprise at least one of:
at least one infused joint;
at least one bonded joint;
at least one prepreg fabric joint; and
at least one hand lay-up (HLU) joint.

18. A wind turbine generator in accordance with claim 17 wherein said wind turbine blade's at least one infused joint comprises:
at least one shell preform member;
said at least one bond cap preform member coupled to said at least one shell preform member; and
at least one resin material infused within at least a portion of said at least one shell preform member and at least a portion of said at least one bond cap preform member.

19. A wind turbine generator in accordance with claim 17 wherein said wind turbine blade's at least one bonded joint comprises:
at least one shell preform member;
said at least one bond cap preform member coupled to said at least one shell preform member; and
at least one bonding substance applied to at least a portion of said at least one shell preform member and at least a portion of said at least one bond cap preform member.

20. A wind turbine generator in accordance with claim 17 wherein each of said wind turbine blade's at least one hand lay-up (HLU) joint and at least one prepreg fabric joint comprise:
at least one shell preform member; and
at least one at least partially resin-impregnated piece coupled to said at least one shell preform member.
